(19) United States
(12) Patent Application Publication
(10) Pub. No.: US 2004/0266487 A1
(43) Pub. Date: Dec. 30, 2004

(54) Voice signal processing methods and systems

(76) Inventors: Jian-Zhou Hou, Yungkang City (TW); Wei-Jou Chen, Jhudong Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/875,841

(22) Filed: Jun. 24, 2004

(30) Foreign Application Priority Data
Jun. 26, 2003 (TW) 92117371

(51) Int. Cl. H04M 1/00; H04B 1/38; H04Q 7/20

(52) U.S. Cl. 455/563; 455/466

(57) ABSTRACT

Voice signal processing method and system. The communication system comprises a first communication device and a second communication device. First, second voice signals and codes corresponding thereto are stored in a second memory unit of the second communication device. Next, the first communication device transmits a first control code and a first voice signal to the second communication device. After a second voice signal corresponding to the first control code is selected from the control codes in the second memory unit, the second communication device synthesizes the first and the second voice signals to yield a third voice signal.

### BACKGROUND

The present invention relates to voice signal processing.

Due to the compact volume and portability of communication devices, users thereof can share voice signals and text messages nearly anywhere. FIG. 1 is a schematic diagram of a communication device 100 utilizing a conventional voice signal processing method. As shown in FIG. 1, the communication device 100 comprises a microphone 102, an ADC (analog-to-digital converter) 104, a transceiver 106, and a speaker 108. The microphone 102 is coupled with the ADC 104 for receiving voice signals. The ADC 104 is coupled between the microphone 102 and the transceiver 106 and converts analog voice signals received from the microphone 102 to digital voice signals. The transceiver 106 is coupled to the speaker 108 and receives wireless signals. The speaker 108 outputs digital voice signals received from the transceiver 106. The communication device 100 receives analog voice signals through the microphone 102. The ADC 104 converts the analog voice signals to digital voice signals. The digital voice signals are then transmitted to the transceiver 106. When communication is established between the communication device 100 and a receiving communication device, digital voice signals are transmitted therebetween through the transceiver 106. The microphone 102 additionally receives background sounds along with the analog voice signals. The ADC 104 performs analog-to-digital conversion of the background sounds. The background sounds are then transmitted to the receiving communication device. Hence, a user of the communication device 100 faces difficulties in selecting the voice signal for transmission, as both voice signals and background sounds are transmitted through the transceiver 106, thus affecting communication quality. Moreover, users of the communication device 100 are unable to share personalized background sounds, i.e., background sounds designated or modified by users or others, with other users via conventional voice communication.

Accordingly, a communication device utilizing another voice signal processing method is implemented to overcome the described disadvantages. FIG. 2 is a schematic diagram of a communication device 200 utilizing another conventional voice signal processing method. The communication device 200 comprises a microphone 202, a memory 204, a voice signal processing unit 206, a transceiver 208, and a control interface (not shown in drawings). The microphone 202 receives analog voice signals. The memory 204 stores voice signals recorded or embedded in the communication device 200. The voice signal processing unit 206 synthesizes voice signals received from the microphone 202 and voice signals stored in the memory 204. The synthesized voice signals are transmitted to the transceiver 208 for output. Thus, both voice signals from the microphone 202 and voice signals stored in the memory 204 can be received.

Control signals are input through the control interface to adjust volume or select voice signals stored in the memory 204. By adjusting input and output of voice signals, personalized voice signals, i.e., background sounds designated or modified by users or others, can be transmitted to others, which is impossible with the conventional communication device 100.

In this method, however, voice signals received from the microphone 202 and voice signals stored in the memory 204 is typically synthesized before transmission via communication networks. The communication networks typically have adequate communication bandwidth to maintain the quality of a voice signal when transmitting high-fidelity or stereo voice signals. Presently, communication network systems, designed for voice communication, degrade the quality of high fidelity or stereo voice signals. Additionally, voice signals cannot be freely modified on the receiving end to create personalized voice signals.

### SUMMARY

An embodiment of a system for voice signal processing comprises a first communication device and a second communication device. The second communication device stores second voice signals and control codes corresponding thereto in a second memory unit. The first communication device is configured to transmit a first control code and a first voice signal to the second communication device. The second communication device synthesizes the first and the second voice signals to yield a third voice signal for output after a second voice signal corresponding to the first control code is selected from the control codes in the second memory unit.

Another embodiment of a system comprises a first communication device comprising a user interface for input of a control signal, a first microphone for receiving a first voice signal, a control code generator controlled by the control signal to generate a first control code, and a first transceiver transmitting the first control code and the first voice signal, and a second communication device having a second transceiver receiving the first control code and the first voice signal, a second memory unit storing second voice signals and control codes corresponding thereto for selecting a second voice signal corresponding to the first control code therefrom when the first control code is received, and a second voice signal processing unit synthesizing the first voice signal and the second voice signal selected from the second memory unit to yield a third voice signal.

A detailed description is given in the following embodiments with reference to the accompanying drawings.

### BRIEF DESCRIPTION OF THE DRAWINGS

Embodiments of the present invention can be more fully understood by reading the subsequent detailed description and examples with references made to the accompanying drawings, wherein:

FIG. 1 is a schematic diagram of a communication device utilizing a conventional voice signal processing method.

FIG. 2 is a schematic diagram of a communication device utilizing another conventional voice signal processing method.

FIG. 3 is a schematic diagram of an embodiment of a communication system.

FIG. 4a is a diagram showing an embodiment of a method for voice signal processing.

FIG. 4b is a diagram showing another embodiment of a method for voice signal processing.

FIG. 5 is a schematic diagram of another embodiment of a system for voice signal processing.

FIG. 6 is a schematic diagram of another embodiment of a system for voice signal processing.

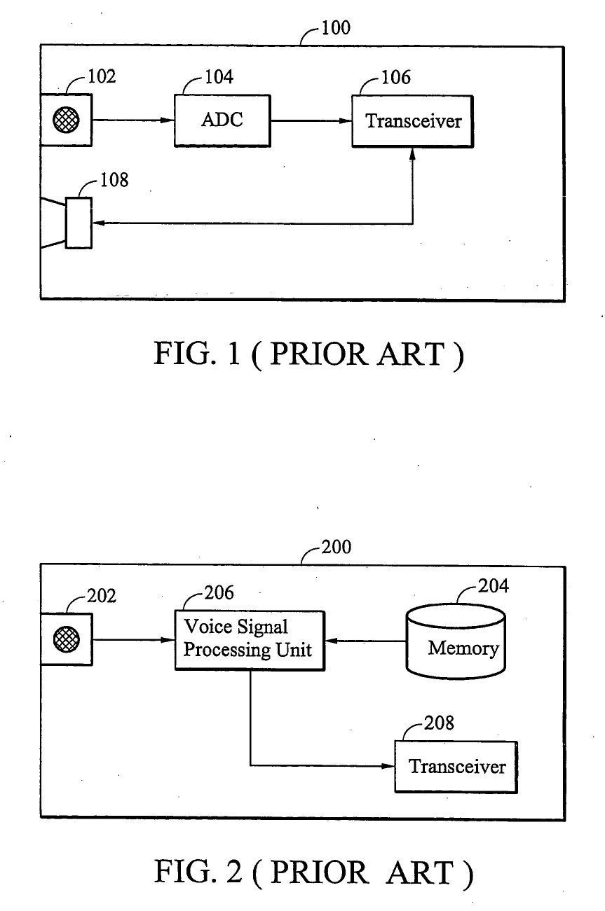

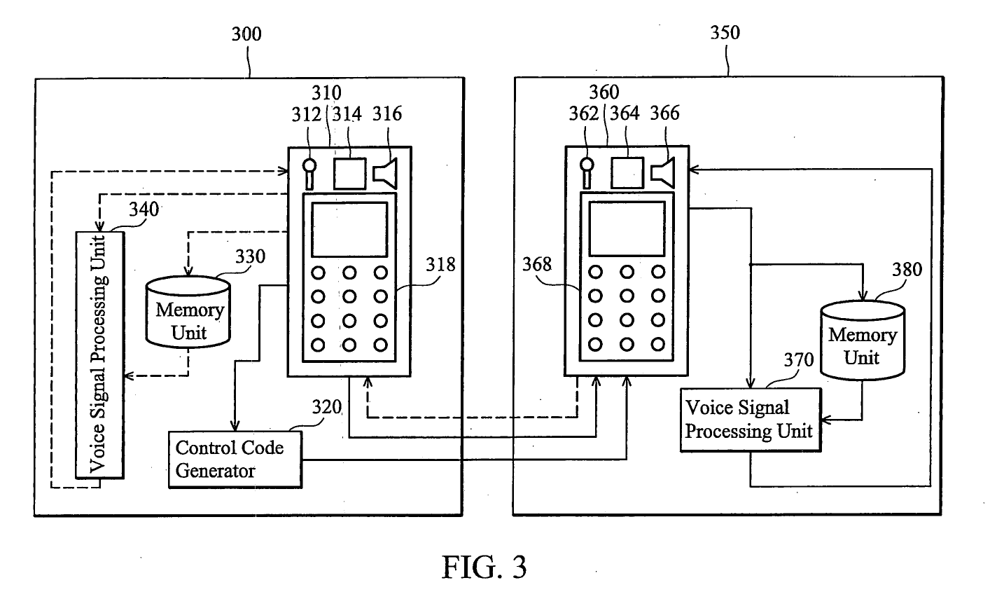

### DETAILED DESCRIPTION

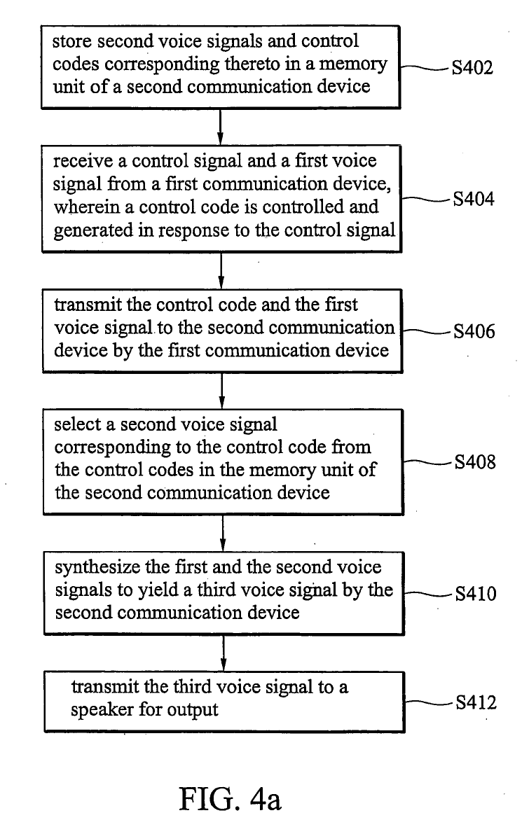

FIG. 3 is a schematic diagram of an embodiment of a communication system. As shown in FIG. 3, the system comprises a first communication device 300 and a second communication device 350. In FIG. 3, when the first communication device 300 serves as a transmitter and the second communication device 350 serves as a receiver, communication signals between the two communication devices are represented as solid lines. Conversely, when the first communication device 300 serves as a receiver and the second communication device 350 serves as a transmitter, communication signals between the two communication devices are represented as dashed lines.

The first communication device 300 comprises a human-machine interface 310, a control code generator 320, a memory unit 330, and a voice signal processing unit 340. The human-machine interface 310 comprises a microphone 312, a transceiver 314, a speaker 316, and a user interface 318. The memory unit 330 stores voice signals recorded by users or embedded in the first communication device 300, as well as control signals corresponding thereto. The voice signals stored in the memory unit 330, such as human voices, musical sounds, nature sounds, and so on, are referred to hereinafter as fifth voice signals. Phone numbers are input via the user interface 318. Moreover, the user interface 318 receives control signals input by users. The user interface 318 can be a graphic user interface (GUI), a keyboard, or other interface capable of receiving user input.

The second communication device 350 comprises a human-machine interface 360, a voice signal processing unit 370, and a memory unit 380. The human-machine interface 360 comprises a microphone 362, a transceiver 364, a speaker 366, and a user interface 368. The memory unit 380 stores voice signals recorded or embedded in the second communication device 350, as well as control codes corresponding thereto. The control codes can be DTMF (Dual Tone Multi-Frequency) dial-up instructions or other control signals transmitted in voice communication. The voice signals stored in the memory unit 380, such as human voices, music, nature sounds, and so on, are referred to hereinafter as second voice signals. The user interface 368 can be a graphic user interface (GUI) or a keyboard conventionally used in voice communication to receive user input, for example, pressing a key press indicating users accept or refuse an incoming phone call.

When the first communication device 300 serves as a transmitter and the second communication device 350 serves as a receiver, the microphone 312 receives a user voice signal as a first voice signal. The user interface 318 receives a user input control signal, and the control code generator 320 receives the control signal from the user interface 318 to generate a control code. The transceiver 314 transmits the control code and the first voice signal to the transceiver 364 of the second communication device 350 by short messages (SMS), GPRS (General Packet Radio Service) digital pockets, voice channels, or others.

When the transceiver 364 receives the control code and the first voice signal, a second voice signal corresponding to the control code is selected from the memory unit 380. The voice signal processing unit 370 processes the first voice signal received from the transceiver 364 and the second voice signal from the memory unit 380, and thus the first and the second voice signals are synthesized to yield a third voice signal. The third voice signal is then transmitted to the speaker 366 for output.

When the second communication device 350 serves as a transmitter and the first communication device 300 serves as a receiver, the microphone 362 receives a user voice signal as a fourth voice signal. The transceiver 366 transmits the fourth voice signal received from the microphone 362 to the transceiver 314 of the first communication device 300.

The user interface 318 is used for input of a control signal. After the control signal is received, a fifth voice signal corresponding to the control signal is selected from the memory unit 330.

The voice signal processing unit 340 processes the fourth voice signal received from the transceiver 314 and the fifth voice signal from the memory unit 330, and thus the fourth and the fifth voice signals are synthesized to yield a sixth voice signal. The sixth voice signal is then transmitted to the speaker 316 for output.

Note that the voice signal processing unit 340 or 370 can process any two voice signals by a synthesizing method or other signal processing methods. The processing method is not limited to the disclosed embodiment, and the scope of the appended claims should be accorded the broadest interpretation so as to encompass all such methods.

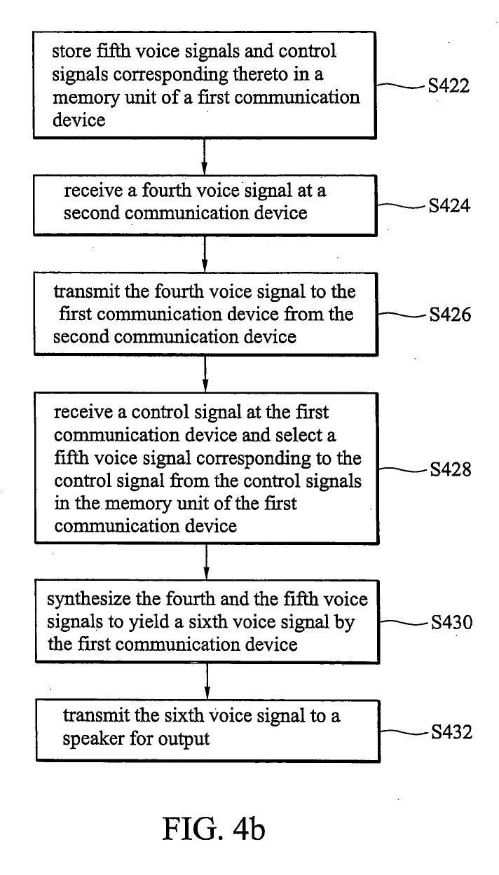

FIG. 4a is a diagram showing an embodiment of a method for voice signal processing. FIG. 4b is a diagram showing another embodiment of a method for voice signal processing. Referring to FIGS. 3, 4a, and 4b, after voice communication is established between the first and the second communication devices 300 and 350, voice communication can be performed. FIG. 4a shows the steps of the voice signal processing method when the first communication device 300 serves as a transmitter and the second communication device 350 serves as a receiver. FIG. 4b shows the steps of the voice signal processing method when the second communication device 350 serves as a transmitter and the first communication device 300 serves as a receiver.

As shown in FIG. 4a, first, in step S402, the second voice signals and the control codes corresponding thereto are stored in the memory unit 380 of the second communication device 350. The memory unit 380 of the second communication device 350 stores predefined voice signals and control codes corresponding thereto. The voice signals can be further stored in the memory unit 380 in accordance with user's requirements after voice signals are input via the microphone 362 of the second communication device 350 or directly from an external source. Note that the voice signal input method is not limited to the disclosed embodiment, and the scope of the appended claims should be accorded the broadest interpretation so as to encompass all suitable methods.

Next, in step S404, the first communication device 300 receives a control signal and a first voice signal, and the control signal controls and generates a control code. When the first communication device 300 serves as a transmitter and the second communication device 350 serves as a receiver, the microphone 312 of the first communication device 300 receives a user voice signal as the first voice signal. The user interface 318 of the first communication device 300 receives the user input control signal and transmits the control signal to the control code generator 320 for generating a corresponding control code.

Further, in step S406, the first communication device 300 transmits the control code and the first voice signal to the second communication device 350. The transceiver 314 of the first communication device 300 transmits the control code and the first voice signal, and the transceiver 364 of the second communication device 350 receives the control code and the first voice signal transmitted from the first communication device 300.

Then, in step S408, the transceiver 364 transmits the received control code to the memory unit 380, and a second voice signal corresponding to the control code is selected from the control codes in the memory unit 380.

After the second voice signal corresponding to the control code is selected from the memory unit 380, in step S410, the second communication device 350 synthesizes the first and the second voice signals to yield a third voice signal. The voice signal processing unit 370 is a processor capable of executing a processing method. In embodiments of the present invention, the voice signal processing unit 370 processes the first voice signal received from the transceiver 364 and the second voice signal from the memory unit 380, and thus the first and the second voice signals are synthesized to yield a third voice signal. Thus, any combination of voice signals stored in the memory unit 380 can be synthesized by the voice signal processing unit 370 to yield a synthesized new voice signal in accordance with user requirements.

Finally, in step S412, the third voice signal is transmitted to the speaker 366 for output, the second communication device 350. Note that the synthesized voice signal can be output either by the speaker 366 or by two separate speakers respectively for output of the first and the second voice signals.

FIG. 4b shows the method of voice signal processing when the second communication device 350 serves as a transmitter and the first communication device 300 serves as a receiver. As shown in FIG. 4b, first, in step S422, the fifth voice signals and the control signals corresponding thereto are stored in the memory unit 330 of the first communication device 300. The memory unit 300 of the first communication device 300 stores predefined voice signals and control signals corresponding thereto. The voice signals can be further stored in the memory unit 330 in accordance with user's requirements after voice signals are input via the microphone 312 of the first communication device 300 or directly from an external source. Note that the voice signal input method is not limited to the disclosed embodiment, and the scope of the appended claims should be accorded the broadest interpretation so as to encompass all suitable methods.

Next, in step S424, the second communication device 350 receives a fourth voice signal. When the second communication device 350 serves as a transmitter and the first communication device 300 serves as a receiver, the microphone 362 of the second communication device 350 receives a user voice signal as the fourth voice signal.

Further, in step S426, the second communication device 350 transmits the fourth voice signal to the first communication device 300. The transceiver 364 of the second communication device 350 transmits the fourth voice signal, and the transceiver 314 of the first communication device 300 receives the fourth voice signal transmitted from the second communication device 350.

Then, in step S428, the first communication device 300 receives a control signal, and a fifth voice signal corresponding to the control signal is selected from the control signals stored in the memory unit 330. The user interface 318 of the first communication device 300 receives and transmits the user input control signal to the control code generator 320 for generating a corresponding control code.

After the fifth voice signal corresponding to the control signal is selected from the memory unit 330, in step S430, the first communication device 300 synthesizes the fourth and the fifth voice signals to yield a sixth voice signal. The voice signal processing unit 340 is a processor capable of executing a processing method. In this embodiment of the present invention, the voice signal processing unit 340 processes the fourth voice signal received from the transceiver 314 and the fifth voice signal from the memory unit 330, and thus the fourth and the fifth voice signals are synthesized to yield a sixth voice signal. Thus, any combination of voice signals stored in the memory unit 330 can be synthesized by the voice signal processing unit 340 to yield a synthesized new voice signal in accordance with user requirements.

Finally, in step S432, the sixth voice signal is transmitted to the speaker 316 for output to the first communication device 300. Note that the synthesized voice signal can be output either by the speaker 316 or by two separate speakers respectively outputting the fourth and the fifth voice signals.

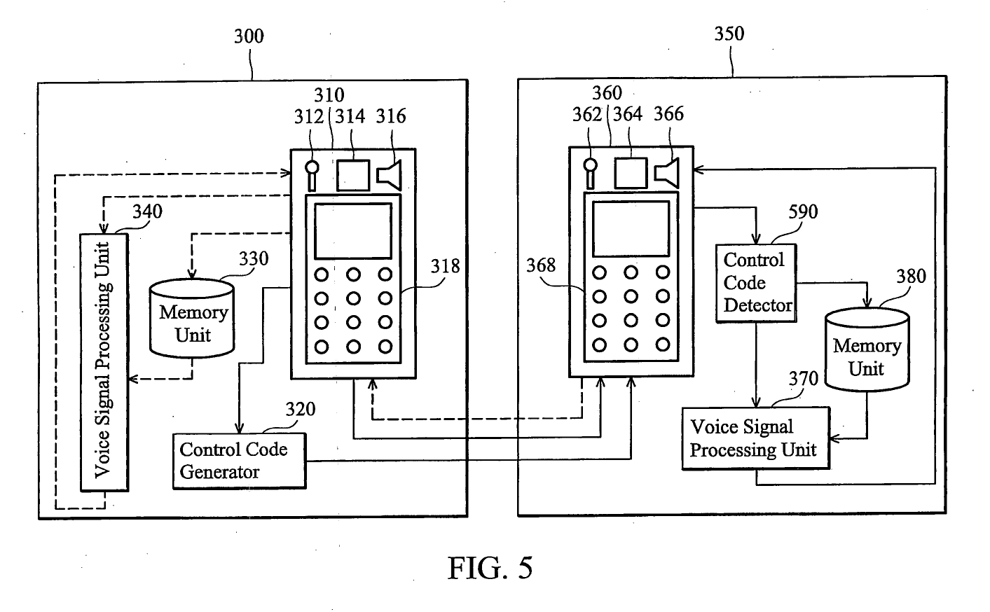

FIG. 5 is a schematic diagram of another embodiment of a system for voice signal processing. As shown in the drawings, with the exception of a control code detector 590 added in the second communication device 350 in FIG. 5, all other electronic components and operating mechanisms thereof in FIGS. 3 and 5 are the same and thus are not described herein for simplicity. The control code detector 590 is used to separate the control code and the first voice signal, both received from the transceiver 364, for transmission respectively to the memory unit 380 and the voice signal processing unit 370.

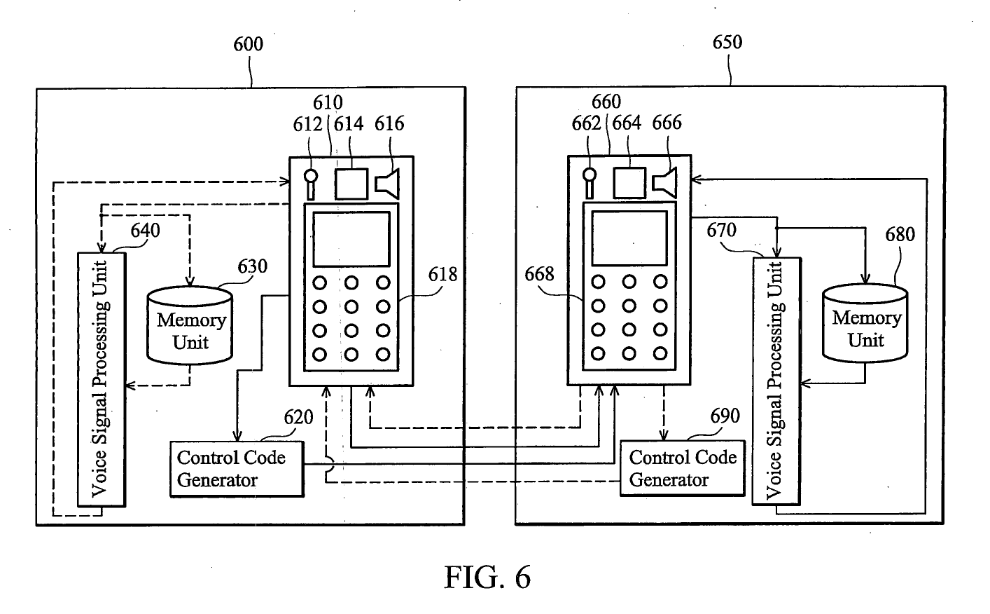

FIG. 6 is a schematic diagram of another embodiment of a system for voice signal processing. As shown in FIG. 6, the communication system comprises a first communication device 600 and a second communication device 650. When voice communication is established, voice communication can proceed between the two communication devices. In FIG. 6, when the first communication device 600 serves as a transmitter and the second communication device 650 serves as a receiver, communication signals between the two communication devices are represented as solid lines. Conversely, when the first communication device 600 serves as a receiver and the second communication device 650 serves as a transmitter, communication signals between the two communication devices are represented as dashed lines.

The first communication device 600 comprises a human-machine interface 610, a control code generator 620, a memory unit 630, and a voice signal processing unit 640. The human-machine interface 610 comprises a microphone 612, a transceiver 614, a speaker 616, and a user interface 618. The memory unit 630 stores voice signals recorded by users or embedded in the first communication device 600, control signals corresponding thereto, and control codes corresponding thereto. The control codes can be DTMF (Dual Tone Multi-Frequency) dial-up instructions or other control signals transmitted via a voice communication system. The voice signals stored in the memory unit 630, such as human voices, music, nature sounds, and so on, are referred to hereinafter as fifth voice signals. The user interface 618 receives desired phone numbers as input via a voice communication system. The user interface 618 additionally receives the user input control signals. The user interface 618 can be a graphic user interface (GUI), a keyboard, or other interface capable of receiving user input.

The second communication device 650 comprises a human-machine interface 660, a voice signal processing unit 670, a memory unit 680, and a control code generator 629. The human-machine interface 660 comprises a microphone 662, a transceiver 664, a speaker 666, and a user interface 668. The memory unit 680 stores voice signals recorded by users or embedded in the second communication device 350, control codes corresponding thereto, and control signals corresponding thereto. The control codes can be DTMF (Dual Tone Multi-Frequency) dial-up instructions or other control signals transmitted via a voice communication system. The voice signals stored in the memory unit 680, such as human voices, musical sounds, natural sounds, and so on, are referred to as second voice signals hereinafter. The user interface 668 receives desired phone numbers as input via a voice communication system. The user interface 668 additionally receives the user input control signals. The user interface 668 can be a graphic user interface (GUI), a keyboard, or other interfaces capable of receiving user inputs.

Furthermore, when an additional voice signal receiving module is configured in the communication device 600 or 650, external voices can be input by wire and stored in the memory unit 630 or 680 respectively. There numerous ways to input voice signals and description thereof is omitted for simplicity.

When the first communication device 600 serves as a transmitter and the second communication device 650 serves as a receiver, the microphone 612 receives a user voice signal as a first voice signal. A user of the first communication device 600 can select whether to transmit other voice signals to the second communication device 650, such that, for example, the user thereof can hear designated background sounds transmitted therefrom.

If a user of the first communication device 600 wants to share designated background sounds with the second communication device 650, a user thereof can input a control signal through the user interface 618. The control code generator 620 receives the control signal from the user interface 618 to generate a control code. The transceiver 614 transmits the control code and the first voice signal to the transceiver 664 of the second communication device 650.

Subsequently, the transceiver 664 transmits the received control code to the memory unit 680, and a second voice signal corresponding to the control code is selected from the memory unit 680. The first voice signal received from the transceiver 664 and the second voice signal from the memory unit 680 are transmitted to the voice signal processing unit 670. The voice signal processing unit 670 processes the first and the second voice signals, and thus the first and the second voice signals are synthesized to yield a third voice signal. The third voice signal is then transmitted to the speaker 666 for output.

If users of the first communication device 600 do not want to share designated background sounds with users of the receiver, the transceiver 614 transmits the first voice signal to the transceiver 664 of the second communication device 650.

When the transceiver 664 receives the first voice signal only, or when a user of the second communication device 650 want to modify received voice signals, a user thereof input a control signal through the user interface 668. When the control signal is received by the memory unit 680, a second voice signal corresponding to the control signal is selected from the memory unit 680. The first voice signal received from the transceiver 664 and the second voice signal from the memory unit 680 are transmitted to the voice signal processing unit 670. The voice signal processing unit 670 processes the first and the second voice signals, and thus the first and the second voice signals are synthesized to yield a third voice signal. The third voice signal is then transmitted to the speaker 666 for output.

When the second communication device 650 serves as a transmitter and the first communication device 600 serves as a receiver, the microphone 662 receives a user voice signal as a fourth voice signal. A user of the second communication device 650 can select whether to transmit other voice signals to the first communication device 600, such that, for example, the users thereof can hear designated background sounds transmitted therefrom.

If a user of the second communication device 650 wants to share designated background sounds with the first communication device 600, a user thereof can input a control signal through the user interface 668. The control code generator 690 receives the control signal from the user interface 668 to generate a control code. The transceiver 664 transmits the control code and the fourth voice signal to the transceiver 614 of the first communication device 600.

Subsequently, the transceiver 614 transmits the received control code to the memory unit 630, and a fifth voice signal corresponding to the control code is selected from the memory unit 630. The fourth voice signal received from the transceiver 614 and the fifth voice signal from the memory unit 630 are transmitted to the voice signal processing unit 640. The voice signal processing unit 640 processes the fourth and the fifth voice signals, and thus the fourth and the fifth voice signals are synthesized to yield a sixth voice signal. The sixth voice signal is then transmitted to the speaker 616 for output.

If a user of the second communication device 650 does not want to share designated background sounds with the receiver, the transceiver 664 transmits the fourth voice signal to the transceiver 614 of the first communication device 600.

When the transceiver 614 receives the fourth voice signal only, or when a user of the first communication device 600 wants to modify received voice signals, a control signal is input through the user interface 618. When the control signal is received by the memory unit 630, a fifth voice signal corresponding to the control signal is selected from the memory unit 630. The fourth voice signal received from the transceiver 614 and the fifth voice signal from the memory unit 630 are transmitted to the voice signal processing unit 640. The voice signal processing unit 640 processes the fourth and the fifth voice signals, and thus the fourth and the fifth voice signals are synthesized to yield a sixth voice signal. The sixth voice signal is then transmitted to the speaker 616 for output.

Note that the voice signal processing unit 640 or 670 can process any two voice signals by a synthesizing method or other signal processing methods. The processing method is not limited to the disclosed embodiment, and the scope of the appended claims should be accorded the broadest interpretation so as to encompass all such methods.

Therefore, the voice signal processing methods and the communication systems utilizing the methods disclosed in the embodiments of the present invention are used to share designated background sounds between users under low bandwidth communication conditions enabling reliable communication quality.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A voice signal processing method, applied in a communication system having a first communication device and a second communication device, comprising the steps of:
storing second voice signals and control codes corresponding thereto in a second memory unit of the second communication device;
transmitting a first control code and a first voice signal to the second communication device by the first communication device;
selecting a second voice signal corresponding to the first control code from the control codes and second voice signals in the second memory unit; and
synthesizing the first and the second voice signals to yield a third voice signal by the second communication device.

2. The voice signal processing method as claimed in claim 1 further comprising:
inputting a control signal to the first communication device, the control signal generating the first control code.

3. The voice signal processing method as claimed in claim 1 further comprising:
playing the third voice signal via a second speaker of the second communication device.

4. The voice signal processing method as claimed in claim 1, wherein the first voice signal is received by a first microphone of the first communication device.

5. The voice signal processing method as claimed in claim 1 further comprising:
storing fourth voice signals and control codes corresponding thereto in a first memory unit of the first communication device;
receiving a fifth voice signal by the second communication device;
transmitting a second control code and the fifth voice signal to the first communication device by the second communication device;
selecting a fourth voice signal corresponding to the second control code from the control codes and fourth voice signals from the first memory unit; and
synthesizing the fourth and the fifth voice signals to yield a sixth voice signal by the first communication device.

6. The voice signal processing method as claimed in claim 5 further comprising:
playing the sixth voice signal via a first speaker of the first communication device.

7. The voice signal processing method as claimed in claim 5, wherein the fifth voice signal is received by a second microphone of the second communication device.

8. The voice signal processing method as claimed in claim 1, wherein the first control code is transmitted by short messages (SMS).

9. A communication system implementing the method as claimed in claim 5.

10. A communication system, comprising:
a first communication device having:
a user interface for input of a control signal;
a first microphone for receiving a first voice signal;
a control code generator controlled by the control signal to generate a first control code; and
a first transceiver transmitting the first control code and the first voice signal; and
a second communication device having:
a second transceiver receiving the first control code and the first voice signal;
a second memory unit storing second voice signals and control codes corresponding thereto for selecting a second voice signal corresponding to the first control code therefrom when the first control code is received; and
a second voice signal processing unit synthesizing the first and the second voice signals to yield a third voice signal.

11. The communication system as claimed in claim 10, wherein the second communication device further comprises a second speaker for outputting the third voice signal.

12. The communication system as claimed in claim 10, wherein the second communication device further comprises a control code detector coupled with the second transceiver for separating the first control code and the first voice signal for transmission respectively to the second memory unit and the second voice signal processing unit.

13. The communication system as claimed in claim 10, wherein the first control code is transmitted by short messages (SMS) to the second communication device.

14. The communication system as claimed in claim 10, wherein the second communication device further comprises a second microphone receiving a fourth voice signal, wherein the fourth voice signal is transmitted to the first transceiver by the second transceiver.

15. The communication system as claimed in claim 14, wherein the first communication device further comprises:
a first memory unit storing fifth voice signals and control signals corresponding thereto for selecting a fifth voice signal corresponding to the control signal therefrom when the control signal is input via the user interface; and
a first voice signal processing unit synthesizing the fourth and the fifth voice signals to yield a sixth voice signal, wherein the fourth voice signal is received by the first transceiver for transmission to the first voice signal processing unit.

16. The communication system as claimed in claim 15, wherein the first communication device further comprises a first speaker outputting the sixth voice signal.
